(19) United States
(12) Patent Application Publication
(10) Pub. No.: US 2021/0019349 A1
(43) Pub. Date: Jan. 21, 2021

(54) BIAS REDUCTION IN CROWDSOURCED TASKS

(71) Applicant: International Business Machines Corporation, Armonk, NY (US)

(72) Inventors: Aniya Aggarwal, New Delhi (IN); Diptikalyan Saha, Bangalore (IN); Kalapriya Kannan, Bangalore (IN); Kuntal Dey, New Delhi (IN); Pranay Kumar Lohia, Bhagalpur (IN); Seema Nagar, Bangalore (IN)

(21) Appl. No.: 16/517,044

(22) Filed: Jul. 19, 2019

(51) Int. Cl. G06F 16/9032; G06F 16/907; G06F 16/9035; G06F 9/48; G06F 9/445; G06Q 10/10

(52) U.S. Cl. CPC G06F 16/90328; G06F 16/907; G06F 16/9035; G06Q 50/01; G06F 9/44578; G06Q 10/103; G06F 9/4881

(57) ABSTRACT

One embodiment provides a method, including: identifying at least one protected attribute of a task of annotating information, wherein the task is assigned to at least one crowdsourced worker for performance of the task; generating at least one question for detecting bias of the at least one crowdsourced worker with respect to the at least one protected attribute, the at least one question comprising a previously provided annotation; providing the at least one question to the at least one crowdsourced worker at a period during performance of the task; computing a bias of the at least one crowdsourced worker with respect to the at least one protected attribute by comparing (i) an annotation provided by the crowdsourced worker to the at least one question and (ii) the previously provided annotation; and updating a profile of the at least one crowdsourced worker with the computed bias.

### BACKGROUND

Bias represents a prejudice or unfairness towards a particular group. If a user or an entity has a particular bias, for example, the user likes one sports team over another sports team, this bias can sway the opinion of the user or entity. This bias can cause a user or entity to have preconceived ideas regarding particular people, entities, text, images, or the like. For example, if the user reads a news article criticizing the favored sports team, the user may automatically assume that the news article is inaccurate, regardless of the facts. Thus, in situations where a user is asked to perform a task with respect to different information, the user may allow bias to influence the performance of the task. For example, if the user is labeling images and identifying different entities within the image, the bias of the user may influence the provided labels and may result in inaccurate information labels or a misrepresentation of the information. Attributes or features that should not be used to influence a decision are referred to as a protected attribute, meaning the decision should not be based upon or influenced by that attribute.

### BRIEF SUMMARY

In summary, one aspect of the invention provides a method, comprising: identifying at least one protected attribute of a task of annotating information, wherein the task is assigned to at least one crowdsourced worker for performance of the task; generating at least one question for detecting bias of the at least one crowdsourced worker with respect to the at least one protected attribute, wherein the at least one question is (i) related to the task and (ii) corresponds to the at least one protected attribute, the at least one question comprising a previously provided annotation allowing for comparison of an annotation provided by the at least one crowdsourced worker; providing the at least one question to the at least one crowdsourced worker at a period during performance of the task by the crowdsourced worker; computing a bias of the at least one crowdsourced worker with respect to the at least one protected attribute by comparing (i) an annotation provided by the crowdsourced worker to the at least one question and (ii) the previously provided annotation of the at least one question; and updating a profile of the at least one crowdsourced worker with the computed bias.

Another aspect of the invention provides an apparatus, comprising: at least one processor; and a computer readable storage medium having computer readable program code embodied therewith and executable by the at least one processor, the computer readable program code comprising: computer readable program code configured to identify at least one protected attribute of a task of annotating information, wherein the task is assigned to at least one crowdsourced worker for performance of the task; computer readable program code configured to generate at least one question for detecting bias of the at least one crowdsourced worker with respect to the at least one protected attribute, wherein the at least one question is (i) related to the task and (ii) corresponds to the at least one protected attribute, the at least one question comprising a previously provided annotation allowing for comparison of an annotation provided by the at least one crowdsourced worker; computer readable program code configured to provide the at least one question to the at least one crowdsourced worker at a period during performance of the task by the crowdsourced worker; computer readable program code configured to compute a bias of the at least one crowdsourced worker with respect to the at least one protected attribute by comparing (i) an annotation provided by the crowdsourced worker to the at least one question and (ii) the previously provided annotation of the at least one question; and computer readable program code configured to update a profile of the at least one crowdsourced worker with the computed bias.

An additional aspect of the invention provides a computer program product, comprising: a computer readable storage medium having computer readable program code embodied therewith, the computer readable program code executable by a processor and comprising: computer readable program code configured to identify at least one protected attribute of a task of annotating information, wherein the task is assigned to at least one crowdsourced worker for performance of the task; computer readable program code configured to generate at least one question for detecting bias of the at least one crowdsourced worker with respect to the at least one protected attribute, wherein the at least one question is (i) related to the task and (ii) corresponds to the at least one protected attribute, the at least one question comprising a previously provided annotation allowing for comparison of an annotation provided by the at least one crowdsourced worker; computer readable program code configured to provide the at least one question to the at least one crowdsourced worker at a period during performance of the task by the crowdsourced worker; computer readable program code configured to compute a bias of the at least one crowdsourced worker with respect to the at least one protected attribute by comparing (i) an annotation provided by the crowdsourced worker to the at least one question and (ii) the previously provided annotation of the at least one question; and computer readable program code configured to update a profile of the at least one crowdsourced worker with the computed bias.

A further aspect of the invention provides a method, comprising: identifying bias of an annotator selected from a plurality of annotators to perform a task, the task having at least one protected attribute, wherein the identifying bias comprises: creating at least one question for testing the bias of the annotator with respect to the at least one protected attribute, wherein the at least one question (i) is semantically related to the task and (ii) has a known annotation not including bias; identifying a point within the task to present the at least one question to the annotator; presenting the at least one question to the annotator at the point while the annotator is performing the task; and comparing an annotation provided by the annotator in response to the at least one question to the known annotation of the at least one question, thereby identifying bias of the annotator with respect to the protected attribute; and updating a profile of the annotator based upon the identified bias, thereby identifying the bias of the annotator within the profile.

For a better understanding of exemplary embodiments of the invention, together with other and further features and advantages thereof, reference is made to the following description, taken in conjunction with the accompanying drawings, and the scope of the claimed embodiments of the invention will be pointed out in the appended claims.

### BRIEF DESCRIPTION OF THE SEVERAL VIEWS OF THE DRAWINGS

FIG. 1 illustrates a method of reducing bias in crowdsourced tasks by identifying bias of an annotator performing the crowdsourced task.

FIG. 2 illustrates an example system for reducing bias in crowdsourced tasks by identifying bias of an annotator performing the crowdsourced task.

FIG. 3 illustrates a computer system.

### DETAILED DESCRIPTION

It will be readily understood that the components of the embodiments of the invention, as generally described and illustrated in the figures herein, may be arranged and designed in a wide variety of different configurations in addition to the described exemplary embodiments. Thus, the following more detailed description of the embodiments of the invention, as represented in the figures, is not intended to limit the scope of the embodiments of the invention, as claimed, but is merely representative of exemplary embodiments of the invention.

Reference throughout this specification to “one embodiment” or “an embodiment” (or the like) means that a particular feature, structure, or characteristic described in connection with the embodiment is included in at least one embodiment of the invention. Thus, appearances of the phrases “in one embodiment” or “in an embodiment” or the like in various places throughout this specification are not necessarily all referring to the same embodiment.

Furthermore, the described features, structures, or characteristics may be combined in any suitable manner in at least one embodiment. In the following description, numerous specific details are provided to give a thorough understanding of embodiments of the invention. One skilled in the relevant art may well recognize, however, that embodiments of the invention can be practiced without at least one of the specific details thereof, or can be practiced with other methods, components, materials, et cetera. In other instances, well-known structures, materials, or operations are not shown or described in detail to avoid obscuring aspects of the invention.

The illustrated embodiments of the invention will be best understood by reference to the figures. The following description is intended only by way of example and simply illustrates certain selected exemplary embodiments of the invention as claimed herein. It should be noted that the flowchart and block diagrams in the figures illustrate the architecture, functionality, and operation of possible implementations of systems, apparatuses, methods and computer program products according to various embodiments of the invention. In this regard, each block in the flowchart or block diagrams may represent a module, segment, or portion of code, which comprises at least one executable instruction for implementing the specified logical function(s).

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

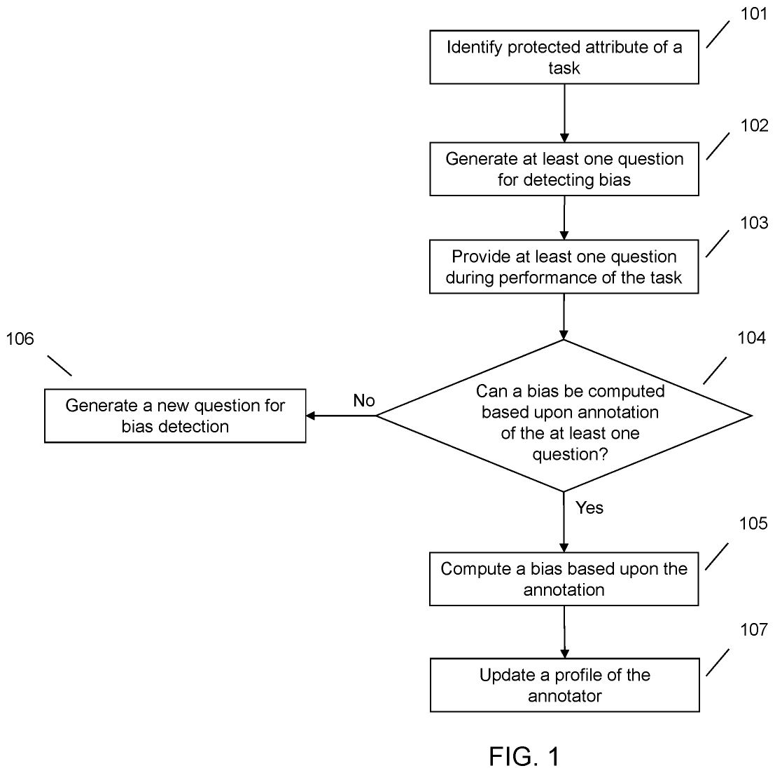

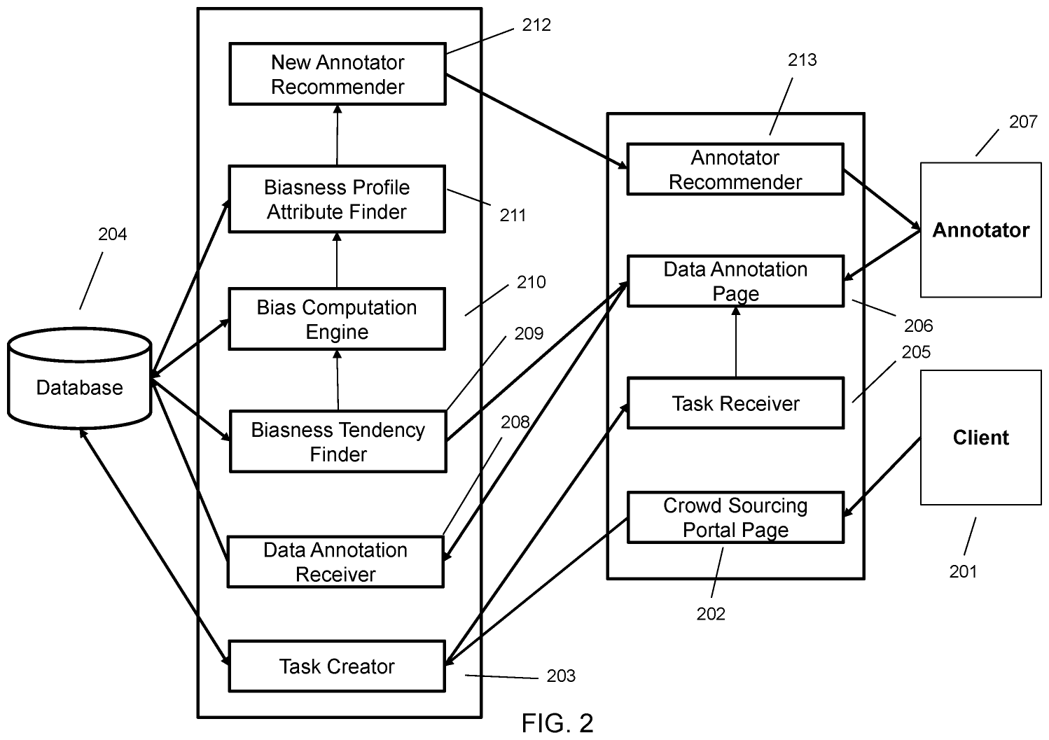

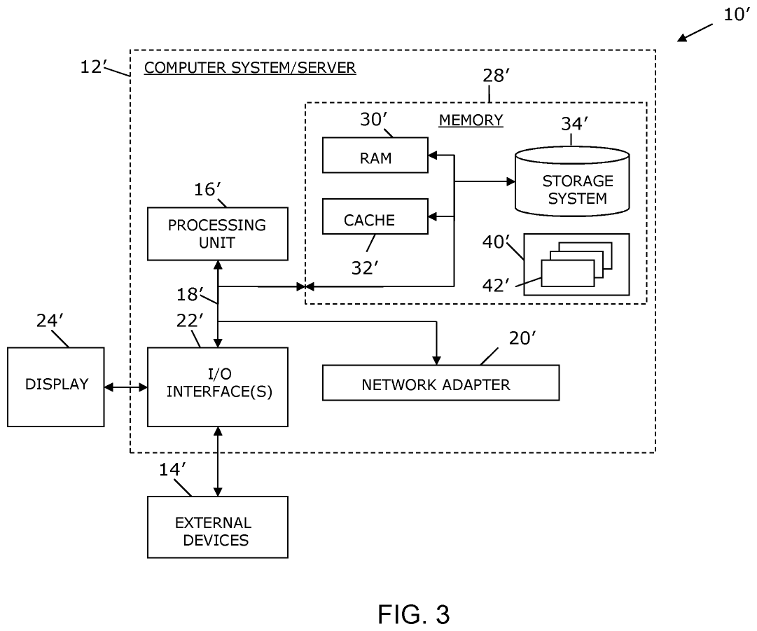

Specific reference will be made here below to FIGS. 1-3. It should be appreciated that the processes, arrangements and products broadly illustrated therein can be carried out on, or in accordance with, essentially any suitable computer system or set of computer systems, which may, by way of an illustrative and non-restrictive example, include a system or server such as that indicated at 12′ in FIG. 3. In accordance with an example embodiment, most if not all of the process steps, components and outputs discussed with respect to FIGS. 1-2 can be performed or utilized by way of a processing unit or units and system memory such as those indicated, respectively, at 16′ and 28′ in FIG. 3, whether on a server computer, a client computer, a node computer in a distributed network, or any combination thereof.

Annotation, for example, labeling, translating, selecting information fulfilling a parameter, or otherwise providing information with regard to a provided information entity, may be time-consuming and tedious. However, annotation of information is an important task because the annotated information can be used for different tasks, for example, training machine-learning models and/or algorithms, distinguishing different entities from each other, and the like. Since annotation is time-consuming but important, entities or users requiring annotation for the performance of a bigger task may employ a crowdsourcing technique for performing the annotation tasks. The entity or user may provide the information requiring annotation to a crowdsourcing platform that includes many different annotators or crowdsourced workers. The annotation task can then be assigned to one or more annotators who then annotate the information using the rules or instructions provided by the requesting entity or annotation client.

The problem with utilizing crowdsourced workers or annotators is that there is not a technique to determine if the annotator is providing annotations in view of a bias of the annotator. In other words, if the annotator is biased towards a particular group or viewpoint, the annotator may annotate the information under this prejudice. This may result in annotations that are inaccurate or misleading. For example, if the annotator has a bias towards orange cats, the annotator may only select images of orange cats when the annotation task is to select images of cats. If this information is being used to train a machine-learning model, the model will then be trained that cats can only be orange and will not associate cats with any other color. While current techniques do allow for the detection of bias within structured or unstructured information, there is no current technique for detecting the bias of the annotator.

Additionally, since the bias of the annotators is not detected and/or tracked, it is difficult to assign annotators to a received task having a protected attribute and ensuring the resulting annotations are not subject to a bias. Rather, the current techniques for assigning an annotator focus on the requirements of the task (e.g., turnaround time, foreign language knowledge, subject matter expertise, etc.) and whether the annotator can fulfill the requirements of the task. Additionally, the current techniques may allow for assignment of a task based upon the historical accuracy or correctness of previously completed tasks by the annotator. However, none of these techniques allow for identifying a bias tendency of an annotator and then selecting annotators for a task that take into account not only the qualifications and historical accuracy of the annotator, but also the bias tendency of the annotator.

Accordingly, an embodiment provides a system and method for reducing bias in crowdsourced tasks by identifying bias of an annotator performing the crowdsourced task. The system may identify a task to be assigned to one or more crowdsourced workers. For example, a client may upload a task to a crowdsourcing system that then can assign a worker to the task. The task may include annotating information, for example, labeling information, selecting images, translating text, labeling text, or otherwise providing information or indications related to the information included in the task. The system may identify a protected attribute included in the information of the task. The information may include more than one protected attribute. A protected attribute is the attribute or feature of the information that should not be used to influence the decision or annotation. For example, a protected attribute may be a physical feature of an entity within the information, a geographic region associated within entities within the information, or any other attribute or feature that the user or client does not want to be used to influence the annotation. The protected attribute may be a default protected attribute or may be identified by the user or client.

In order to determine if the annotator has a bias, the system may generate at least one question for detecting the bias of an annotator or crowdsourced worker. The generated question is semantically related to the task and corresponds to the protected attribute. Generating a question related to the task allows for the detection of bias while ensuring that the annotator does not know the question is a test for bias. The generated question includes a previously provided annotation so that the system knows what the annotation should be under the condition that the annotator has no bias. The system then presents the generated question(s) to the annotator while the annotator is performing the task. Using the annotator's annotation to the presented question, the system can compare this provided annotation to the known annotation to determine if the annotator has bias. Based upon the comparison, the system can compute a bias of the annotator and update the profile of the annotator with the computed bias, if any.

Such a system provides a technical improvement over current systems for reducing bias in tasks. The system can determine if an annotator has bias and, if so, what protected attributes the annotator is biased against. The bias information can then be included in a profile of the annotator, thereby allowing a crowdsourcing system to recommend an annotator for a task in view of the bias of the annotator. In other words, the system is able to determine if an annotator has a bias that would result in inaccurate or misleading annotations for a task. Thus, unlike conventional systems that recommend annotators based only on qualifications and accuracy, the described system allows for a technique of making annotator recommendations by also taking into account the bias of the annotator. This provides a technique for reducing or mitigating worker bias in crowdsourced tasks and, thereby, allows for more accurate and complete annotations. Having more accurate and complete annotations means that downstream tasks that utilize the annotations are also more accurate and complete. Additionally, since the bias of the annotator is known, the bias of the annotator can be used to determine the quality of the completed task. Therefore, the described system and method provides additional information for recommending annotators, resulting in more accurate and complete annotations while still allowing for the use of crowdsourced workers to perform the time-consuming and tedious task of annotating information.

FIG. 1 illustrates a method for reducing bias in crowdsourced tasks by identifying bias of an annotator performing the crowdsourced task. The system may receive or identify a task of annotating information that is to be assigned to one or more crowdsourced workers or annotators. For example, the system may receive an annotation task from a client or other user who uploads or otherwise provides the annotation task to the system. The task may include different types of information annotation. For example, one type of annotation task may include annotating structured information. Structured information is information that is included within a known format, with each value of information belonging to a known attribute, feature, or label, and having a predetermined or specific format. For example, one column of structured information may be a geographical location of an entity corresponding to a row of the structured information. Thus, all the values within that column are known to be geographical locations. Additionally, all values included within a row are known to belong to the entity of the row. Examples of structured information include fields within a document, columns and rows within a spreadsheet, or any other information having a known label or belonging to a known attribute or feature and having a predefined structure.

Another type of annotation task may include annotating unstructured information. Unstructured information is information that does not have a known label or belongs to a known attribute or feature and that does not have a predetermined structure or format. For example, unstructured information may include freeform text that is provided within a comments section of a document. While the system knows that the information belongs to the comments section, the information provided within the comments section can be related to any number of different information labels and may be provided in any number of different formats or structures. Examples of unstructured information include books, news articles, freeform fields within a document, scientific papers, and the like. Other annotation tasks include annotating images, annotating videos, annotating audio, or the like. Thus, annotation may include labeling information, selecting information, converting information from one form to another, or otherwise providing additional information with respect to the information included in the task.

At 101 the system may identify at least one protected attribute included in the task. The protected attribute may be a default protected attribute, for example, an attribute selected or identified by the system based upon the field or subject matter of the task, based upon a list of protected attributes, based upon rules or regulations associated with the task, based upon the type of annotation requested, or the like. For example, a protected attribute may include an attribute that is designated as protected by law. As another example, a task related to professions may include attributes to be treated as protected, whereas the same attribute would not be protected in a task related to animals. The protected attribute may also be identified by the client or user providing the task to the system. For example, the user may identify that color is a protected attribute with respect to a task for identifying cats within images. There are many conventional techniques for detecting or identifying protected attributes. Thus, other techniques for identifying protected attributes are possible and contemplated.

The system may assign the task to one or more crowdsourced workers that are associated with the crowdsourcing system. In other words, a client or other user may provide a task to a crowdsourcing system in order to have the information included in the task be annotated by an annotator or crowdsourced worker associated with the crowdsourcing system. When providing the task, the client may also provide instructions for performing the task. Additionally, the client may provide a list of qualifications required for successfully completing the task. For example, if the annotation task is to translate information from one language to another, the client may indicate that the selected annotator needs to be fluent in both the language of the provided text and the language that the text is to be translated to. In an initial crowdsourced worker selection, the system may rely on traditional techniques for selecting or recommending the worker, for example, the qualifications and historical accuracy of the worker. However, as the system learns the bias of the worker or other workers, as provided in the described system, the system also utilizes the bias of the worker or other workers in providing a recommendation of a worker for a task.

At 102 the system generates at least one question for detecting the bias of the selected or recommended worker. The detection of bias occurs while the worker is performing the task. In other words, the task is assigned to the worker or annotator and, while the annotator is performing or completing the task, the system is determining or detecting whether the worker has a bias with respect to one or more of the identified protected attributes. To detect bias, the system generates questions to be presented to the worker during performance of the task. The questions are generated to be semantically related to the task and also correspond to the protected attribute. This ensures that the worker does not know that the question is being presented to detect bias, so that the worker cannot fool the system by answering the question in a non-biased manner even though the worker does actually have bias. For example, if the annotation task is to select five images of cats and five images that are not cats and provide them to the system, the generated question may be provision of an image of a cat having a particular attribute corresponding to the protected attribute, for example, a particular color of cat. Thus, the worker does not know that the presented image is a bias detection image. Instead, the image appears to be an image included in the task.

In order to accurately detect bias, the generated question has a known annotation or previously provided annotation. This known annotation is the annotation that would be provided if a worker does not have bias. For example, using the cat image example, the image of the cat for bias detection would have a “cat” label indicating that the image is one of a cat regardless of the color of the cat. If the annotator does have bias towards the color of the cat, then the annotator would likely not select the image for provision to the system as an image of a cat and would instead select a different image of a cat of the color preferred by the annotator. The known annotation provides a mechanism for comparing an annotation provided by the worker to the known annotation in order to determine if the worker is biased.

Generating the question(s) may be performed differently based upon the annotation task. Additionally, the number of questions that need to be generated in order to test the bias of the annotator for a particular protected attribute may vary based upon the annotation task and/or the number of possible values for the protected attribute. For example, a question may be generated for each of the possible values for the protected attribute. The generated questions are semantically related to the task. For example, if the task is to identify if a mortgage decision is favorable or unfavorable, the system would generate a question related to identifying if a mortgage decision is favorable or unfavorable as opposed to generating a question identifying if an image includes a stoplight. By maintaining a similarity between the task and the generated questions, the system reduces the likelihood that the annotator identifies that the question is a bias detection test question.

Using annotation of structured information as a first example, the question generation may include generating a question for each possible value of the protected attribute. For example, if the protected attribute has two possible values, for example, yes and no, the system will generate two questions, one for each of the two possible values. Thus, for this example, the system would generate a question that is semantically related to the task and having a “yes” value for the protected attribute. The system would then take the same question and only change the protected attribute to a “no” value. Thus, the only difference between the two questions is the value of the protected attribute. By only changing the protected attribute value, the system can attribute any difference in annotation by the annotator to the protected attribute, and, therefore, a bias by the annotator with respect to that protected attribute. Once the questions are generated, the system associates or links the questions together so that the system knows that these questions are being used to test for bias with respect to the protected attribute. The system also stores the annotation that would be provided if the annotator is unbiased with the questions for later comparison once the annotator has provided an annotation. For annotation tasks of labeling unstructured information with a particular label, the generation of the question(s) may be performed in a similar manner.

Using annotation of unstructured information, specifically, providing a text answer for unstructured information as a second example, the question generation may include accessing a secondary source. For purposes of this example the example of translating a text document from one language to another language as the annotation task will be used. In order to generate a question semantically related to the annotation task, the system will access a secondary source to find an unstructured text document in the same language as those that need translated in the annotation task. The unstructured text document that the system finds is one where the biasness with regard to the same protected attribute as found in the annotation task is as neutral as possible. Determining the bias of an unstructured document is possible using many different conventional techniques. This found text document will then act as the generated question. Since the system knows that the biasness of the found text document is neutral, any bias that exists in the annotated text document after the annotator has completed the annotation is bias introduced by the annotator.

An annotation task of selecting or providing images corresponding to a specific entity will be used as a third example. To generate the question(s), the system will provide images where the label is already known. The provided images will be images that are similar to or belong to the same category as the images of the annotation task. For example, if the annotation task is to provide three correct images of people in a particular profession and six incorrect images of people in that profession, the system may display images where the profession of the person is known. Therefore, when the annotator selects the image as either a correct or incorrect image, the system can determine whether that selection corresponds to the known label. Additionally, the system may generate other questions for a similar category having images where known bias could exist. For example, if the annotation task image is to select images of cats and the protected attribute is color, the similar category may be to select images of dogs where the same bias (e.g., color of the animal) may occur.

At 103 the system may provide the generated question(s) to the worker at a point in time or period during the performance of the annotation task. In other words, while the worker is completing the annotation task, the system will present the bias detection question(s) to the worker. Determining when to provide the bias detection question during the performance of the task may be based upon a set of rules. These rules may be default rules, for example, a bias detection question should not be the first question, bias detection questions should not occur in sequence, a specific period of time between presentation of bias detection questions should elapse, a number of bias detection questions presented should not be over a particular number or percentage, or the like. Alternatively, the rules may be unique to the annotation task or may be provided by the client when the annotation task is provided. The rules are designed to make it more difficult for the worker to identify bias detection questions or that the system is attempting to identify whether the worker has a bias.

In response to presentation of the bias detection question(s), the worker will provide an annotation. Thus, at 104 the system determines whether a bias can be computed using the annotation provided by the worker. To determine whether a bias can be computed, the system may determine whether the annotation provided by the worker can be compared to the known annotation. If the worker fails to provide an annotation then the system may determine that a bias cannot be computed. Another scenario that may result in an inability to compute a bias is if the provided annotation is significantly different from the known annotation. For example, if the annotation task is to translate unstructured information and the translation is completely different than the known translation, the system may determine that the translation is incorrect and, therefore, a bias cannot be determined.

If a bias cannot be computed at 104, the system may generate a new bias detection question at 106. If, on the other hand, a bias can be computed at 104, the system may compute the bias of the worker at 105 using the annotation of the bias detection question(s) provided by the worker. To compute the bias the system can compare the provided annotation to the known annotation corresponding to the question. For example, if the annotation task was to annotate structured information with a correct label, the system may compare the provided label to the known label of the provided bias detection question. As another example, if the annotation task was to translate an article, the system may compare the provided translation to the bias detection question (e.g., the neutral article) to the known translation of the bias detection question.

The system can then determine if the provided annotation matches the known annotation, where the known annotation identifies an annotation that would be provided if the worker has no bias. Thus, if the annotation provided by the worker does not match the known annotation, the system can infer that the worker has bias. Different types of bias can be computed using different techniques that are based upon the annotation task. For example, a structured information, image provision, label provision, or the like, annotation task may allow for bias computation using disparate impact, elift ratio, or the like, computation techniques. As another example, an annotation task that requires provision of text may allow for bias computation using word vector similarity, term frequency-inverse document frequency (tf-idf) occurrence, or other text similarity computation techniques. Other bias computation techniques are possible and contemplated. The bias computation identifies the bias introduced by the annotator in response to the bias detection question(s).

Based upon the bias computation using the bias detection questions, the system can compute a biasness tendency for the worker and update a profile of the annotator or worker with the biasness tendency at 107. The computed bias tendency may be a bias tendency for a particular protected attribute or may be an overall bias tendency that is based upon a bias tendency across all protected attributes. The bias tendency attribute may be a vector of biasness along the protected attribute or all the protected attributes. For example, if the biasness tendency of the worker correlates very well with the bias introduced into the information through the bias detection questions, then the bias tendency attribute may be identified as biased for the protected attribute associated with the bias detection question. If the biasness tendency attribute of the worker is biased across all or most of the protected attributes, then the worker may be identified as biased and the profile of the worker may be updated to reflect the same. If the biasness tendency attribute of the worker is only biased across a few of the protected attributes, then the worker may be identified as biased only for these attributes and the profile of the worker may be updated to reflect only a bias for these particular protected attributes. If the worker is identified as not having any biasness tendencies, then the biasness tendency attribute may be identified as unbiased for most or all of the protected attributes and the profile may be updated to reflect that the worker is not biased.

Once profiles of annotators or workers are updated with a biasness indication, the system can use this information to recommend a worker for subsequent annotation tasks. In one example, if the worker has a biasness tendency identified in the profile, this information can be used during the selection or recommendation of a worker. For example, a worker who has a biasness with respect to a protected attribute identified in the annotation task may not be recommended for the annotation task, whereas a worker not having a biasness with respect to the protected attribute may be recommended for the task. If, however, the worker has not yet had a biasness tendency identified within a corresponding profile, the system may use profiles of other workers who do have a biasness tendency identified to make a recommendation regarding the worker not having an identified biasness tendency. In this case the system may compare the other profile characteristics of the worker to profiles of workers having known biasness tendencies. The system may then recommend a worker who has a profile similar to workers identified as not having a bias and who has a profile that is dissimilar to workers identified as having a bias. Determining the similarity of profiles may include computing a similarity using similarity computation techniques. A worker who has a similarity score above a particular threshold with respect to an unbiased worker may then be recommended for the task.

FIG. 2 illustrates an overall example system architecture of the described system. A client 201 provides an annotation task to the crowdsourcing system through a crowdsourcing portal page 202. A task creator 203 takes the annotation task to generate the bias detection questions utilizing a database 204. The task creator 203 sends the bias detection questions to a task receiver 205 that determines when the questions should be presented during performance of the task. The task receiver 205 provides the questions to the data annotation page 206 while the annotator 207 is performing the task. The data annotation page 206 provides the responses to the bias detection questions to the data annotation receiver 208 which accesses the known annotations for the bias detection questions from the database 204.

Utilizing the known annotations and the provided annotations, the bias tendency finder 209 identifies any bias within the provided annotations. The identification of bias or no bias is provided to the bias computation engine 210 to compute a bias tendency attribute for the annotator 207. This bias tendency attribute is provided to the database 204 for storage to be associated with the annotator 207. Upon receiving a subsequent annotation task, the biasness profile attribute finder 211 can access the annotator's 207 profile stored in the database 204 to identify the biasness tendency attribute. This information is then used by the new annotator recommender 212 to provide a recommendation of an annotator for the annotation task to the annotator recommender 213.

Such a system provides an improvement over conventional systems for mitigating bias and recommending crowdsourced workers for a task. The described system provides a technique for identifying bias of a crowdsourced worker, thereby allowing for recommendation of crowdsourced workers that will not introduce bias into annotating information. Thus, the annotations are more accurate and complete. Additionally, the detection of bias of a worker is performed in such a manner that the worker does not know that bias is being tested, thereby preventing the worker from being able to fool the system with regards to the bias of the worker. Additionally, since the bias information is included in the profile of the crowdsourced worker, the system can recommend annotators for tasks even if the bias of the annotator is not known, by making recommendations based upon profiles similar to annotators that do not have bias and dissimilar from annotators that have bias. Accordingly, the described system provides a technique for providing better recommendations for crowdsourced workers or annotators in order to reduce or mitigate bias within the desired task, which is not possible using conventional annotator recommendation techniques.

As shown in FIG. 3, computer system/server 12′ in computing node 10′ is shown in the form of a general-purpose computing device. The components of computer system/server 12′ may include, but are not limited to, at least one processor or processing unit 16′, a system memory 28′, and a bus 18′ that couples various system components including system memory 28′ to processor 16′. Bus 18′ represents at least one of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12′ typically includes a variety of computer system readable media. Such media may be any available media that are accessible by computer system/server 12′, and include both volatile and non-volatile media, removable and non-removable media.

System memory 28′ can include computer system readable media in the form of volatile memory, such as random access memory (RAM) 30′ and/or cache memory 32′. Computer system/server 12′ may further include other removable/non-removable, volatile/non-volatile computer system storage media. By way of example only, storage system 34′ can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18′ by at least one data media interface. As will be further depicted and described below, memory 28′ may include at least one program product having a set (e.g., at least one) of program modules that are configured to carry out the functions of embodiments of the invention.

Program/utility 40′, having a set (at least one) of program modules 42′, may be stored in memory 28′ (by way of example, and not limitation), as well as an operating system, at least one application program, other program modules, and program data. Each of the operating systems, at least one application program, other program modules, and program data or some combination thereof, may include an implementation of a networking environment. Program modules 42′ generally carry out the functions and/or methodologies of embodiments of the invention as described herein.

Computer system/server 12′ may also communicate with at least one external device 14′ such as a keyboard, a pointing device, a display 24′, etc.; at least one device that enables a user to interact with computer system/server 12′; and/or any devices (e.g., network card, modem, etc.) that enable computer system/server 12′ to communicate with at least one other computing device. Such communication can occur via I/O interfaces 22′. Still yet, computer system/server 12′ can communicate with at least one network such as a local area network (LAN), a general wide area network (WAN), and/or a public network (e.g., the Internet) via network adapter 20′. As depicted, network adapter 20′ communicates with the other components of computer system/server 12′ via bus 18′. It should be understood that although not shown, other hardware and/or software components could be used in conjunction with computer system/server 12′. Examples include, but are not limited to: microcode, device drivers, redundant processing units, external disk drive arrays, RAID systems, tape drives, and data archival storage systems, etc.

This disclosure has been presented for purposes of illustration and description but is not intended to be exhaustive or limiting. Many modifications and variations will be apparent to those of ordinary skill in the art. The embodiments were chosen and described in order to explain principles and practical application, and to enable others of ordinary skill in the art to understand the disclosure.

Although illustrative embodiments of the invention have been described herein with reference to the accompanying drawings, it is to be understood that the embodiments of the invention are not limited to those precise embodiments, and that various other changes and modifications may be affected therein by one skilled in the art without departing from the scope or spirit of the disclosure.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions. These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method, comprising:
identifying at least one protected attribute of a task of annotating information, wherein the task is assigned to at least one crowdsourced worker for performance of the task;
generating at least one question for detecting bias of the at least one crowdsourced worker with respect to the at least one protected attribute, wherein the at least one question is (i) related to the task and (ii) corresponds to the at least one protected attribute, the at least one question comprising a previously provided annotation allowing for comparison of an annotation provided by the at least one crowdsourced worker;
providing the at least one question to the at least one crowdsourced worker at a period during performance of the task by the crowdsourced worker;
computing a bias of the at least one crowdsourced worker with respect to the at least one protected attribute by comparing (i) an annotation provided by the crowdsourced worker to the at least one question and (ii) the previously provided annotation of the at least one question; and
updating a profile of the at least one crowdsourced worker with the computed bias.

2. The method of claim 1, wherein the task comprises annotating structured information having a protected attribute with a predetermined number of possible known values; and
wherein the generating at least one question comprises generating a plurality of questions equal to the predetermined number, each of the plurality of questions comprising (i) a different value from the possible known values for the protected attribute and (ii) the same previously provided annotation as the other of the plurality of questions.

3. The method of claim 2, wherein the providing the at least one question comprises providing each of the plurality of questions during different periods during performance of the task; and
wherein the computing bias comprises comparing the annotation provided for each of the plurality of questions to the previously provided annotation.

4. The method of claim 1, wherein the task comprises annotating unstructured information having a protected attribute; and
wherein the generating at least one question comprises identifying other unstructured information being previously annotated, the other unstructured information (i) including the protected attribute and (ii) having a neutral bias with respect to the protected attribute.

5. The method of claim 4, wherein the providing the at least one question comprises providing the other unstructured information; and
wherein the computing bias comprises comparing the annotation provided by the at least one crowdsourced worker for the other unstructured information to the previous annotation of the other unstructured information.

6. The method of claim 1, wherein the generating at least one question comprises generating at least one question related to the task by utilizing the semantics of the task to generate at least one question similar to the semantics of the task.

7. The method of claim 1, comprises computing an overall bias tendency for the at least one crowdsourced worker from a computed bias of the at least one crowdsourced worker for a plurality of different protected attributes.

8. The method of claim 1, comprising recommending a crowdsourced worker for a task having a protected attribute based upon the bias of the crowdsourced worker with respect to the protected attribute identified from the profile of the crowdsourced worker.

9. The method of claim 8, wherein the recommending comprises recommending a crowdsourced worker having a profile (i) similar to a crowdsourced worker not having bias for the protected attribute of the task and (ii) dissimilar to a crowdsourced worker having bias for the protected attribute of the task.

10. The method of claim 1, wherein the providing at least one question is based upon a set of rules identifying when to provide the at least one question.

11. An apparatus, comprising:
at least one processor; and
a computer readable storage medium having computer readable program code embodied therewith and executable by the at least one processor, the computer readable program code comprising:
computer readable program code configured to identify at least one protected attribute of a task of annotating information, wherein the task is assigned to at least one crowdsourced worker for performance of the task;
computer readable program code configured to generate at least one question for detecting bias of the at least one crowdsourced worker with respect to the at least one protected attribute, wherein the at least one question is (i) related to the task and (ii) corresponds to the at least one protected attribute, the at least one question comprising a previously provided annotation allowing for comparison of an annotation provided by the at least one crowdsourced worker;
computer readable program code configured to provide the at least one question to the at least one crowdsourced worker at a period during performance of the task by the crowdsourced worker;
computer readable program code configured to compute a bias of the at least one crowdsourced worker with respect to the at least one protected attribute by comparing (i) an annotation provided by the crowdsourced worker to the at least one question and (ii) the previously provided annotation of the at least one question; and
computer readable program code configured to update a profile of the at least one crowdsourced worker with the computed bias.

12. A computer program product, comprising:
a computer readable storage medium having computer readable program code embodied therewith, the computer readable program code executable by a processor and comprising:
computer readable program code configured to identify at least one protected attribute of a task of annotating information, wherein the task is assigned to at least one crowdsourced worker for performance of the task;
computer readable program code configured to generate at least one question for detecting bias of the at least one crowdsourced worker with respect to the at least one protected attribute, wherein the at least one question is (i) related to the task and (ii) corresponds to the at least one protected attribute, the at least one question comprising a previously provided annotation allowing for comparison of an annotation provided by the at least one crowdsourced worker;
computer readable program code configured to provide the at least one question to the at least one crowdsourced worker at a period during performance of the task by the crowdsourced worker;
computer readable program code configured to compute a bias of the at least one crowdsourced worker with respect to the at least one protected attribute by comparing (i) an annotation provided by the crowdsourced worker to the at least one question and (ii) the previously provided annotation of the at least one question; and
computer readable program code configured to update a profile of the at least one crowdsourced worker with the computed bias.

13. The computer program product of claim 12, wherein the task comprises annotating structured information having a protected attribute with a predetermined number of possible known values; and
wherein the generating at least one question comprises generating a plurality of questions equal to the predetermined number, each of the plurality of questions comprising (i) a different value from the possible known values for the protected attribute and (ii) the same previously provided annotation as the other of the plurality of questions.

14. The computer program product of claim 13, wherein the providing the at least one question comprises providing each of the plurality of questions during different periods during performance of the task; and
wherein the computing bias comprises comparing the annotation provided for each of the plurality of questions to the previously provided annotation.

15. The computer program product of claim 12, wherein the task comprises annotating unstructured information having a protected attribute; and
wherein the generating at least one question comprises identifying other unstructured information being previously annotated, the other unstructured information (i) including the protected attribute and (ii) having a neutral bias with respect to the protected attribute.

16. The computer program product of claim 15, wherein the providing the at least one question comprises providing the other unstructured information; and
wherein the computing bias comprises comparing the annotation provided by the at least one crowdsourced worker for the other unstructured information to the previous annotation of the other unstructured information.

17. The computer program product of claim 12, wherein the generating at least one question comprises generating at least one question related to the task by utilizing the semantics of the task to generate at least one question similar to the semantics of the task.

18. The computer program product of claim 12, comprises computing an overall bias tendency for the at least one crowdsourced worker from a computed bias of the at least one crowdsourced worker for a plurality of different protected attributes.

19. The computer program product of claim 12, comprising recommending a crowdsourced worker for a task having a protected attribute based upon the bias of the crowdsourced worker with respect to the protected attribute identified from the profile of the crowdsourced worker.

20. A method, comprising:
identifying bias of an annotator selected from a plurality of annotators to perform a task, the task having at least one protected attribute, wherein the identifying bias comprises:
creating at least one question for testing the bias of the annotator with respect to the at least one protected attribute, wherein the at least one question (i) is semantically related to the task and (ii) has a known annotation not including bias;
identifying a point within the task to present the at least one question to the annotator;
presenting the at least one question to the annotator at the point while the annotator is performing the task; and
comparing an annotation provided by the annotator in response to the at least one question to the known annotation of the at least one question, thereby identifying bias of the annotator with respect to the protected attribute; and
updating a profile of the annotator based upon the identified bias, thereby identifying the bias of the annotator within the profile.
